(19) United States
(12) Patent Application Publication
(10) Pub. No.: US 2004/0153751 A1
(43) Pub. Date: Aug. 5, 2004

(54) Data processing apparatus

(75) Inventors: Chris Marshall, Northport, NY (US); Katsuhisa Muramatsu, Kawasaki-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/684,360

(22) Filed: Oct. 15, 2003

Related U.S. Application Data
(63) Continuation of application No. 09/478,788, filed on Jan. 7, 2000, now abandoned.
Application No. 09/478,788 is a continuation of application No. 08/879,627, filed on Jun. 20, 1997, now abandoned.

(51) Int. Cl. H04L 1/22

(52) U.S. Cl. 714/11

(57) ABSTRACT

A predetermined processing operation and an address used to identify and call a next function are provided in each function for performing predetermined data processing. The functions are stored in memory. This enables data processing operations that involve a plurality of different functions to be edited and performed easily and quickly. For example, after image processing function A has been called, image processing function A executes its predetermined process, and subsequently calls image processing function C. Image processing function C executes its predetermined process, and subsequently returns to the former process.

### BACKGROUND OF THE INVENTION

1. Field of the Invention

This invention relates to data processing apparatus, and in particular to a data processing apparatus that is capable of rapidly performing an optimum process by, for example, calling the next function that is to be executed.

2. Description of Related Art

Image data is captured from a scanner or the like. Due to the storage capacity limits of a memory that stores the captured image data, the image data can be separated into regions, with the respective regions being captured.

The captured image data can be displayed on a display device, or printed on paper before image processing is performed on the captured image data. A number of different data processing operations can be performed on the image data including, for example, a gamma compensation process, a resolution-conversion process, and an outline-adjustment process. These processes must be executed in an appropriate order according to the circumstances. Typically, the order of calling the processes is predetermined and the processes are performed according to the predetermined order before the image data is captured. A processing order for such an example will be described by referring to the flowchart shown in FIG. 6.

Initially in step S1, the optimum processing order is determined, and processing order data, as shown in FIG. 7, is generated. As illustrated in FIG. 7, the processing order data consists of arrangement-type variables (arranged variables), i.e., a plurality of elements arranged in sequential order. The memory address of a function to be called is stored in each element. According to this example, the memory address of image processing function A is stored in the first element of the arranged variables, the memory address of image processing function C is stored in the second element, the memory address of image processing function D is stored in the third element, and the memory address of image processing function B is stored in the fourth element.

In step S2, the next image is captured from an input device such as a scanner. At this time, each region separated from the image data is input as described above. In step S3, according to the processing order data generated in step S1, predetermined image processing operations are sequentially executed on each region of the input image data. In the case of this example, the processing order data as shown in FIG. 7 is generated in step S1, thus, image processing functions A to D are called and are executed in the order of image processing functions A, C, D and B.

In step S4, a determination is made as to whether or not image processing has been performed for all the regions of the image data. If the image processing has not been performed for all the regions of the image data, the process returns to step S2, where the steps from step S2 to step S4 are repeatedly executed. If the image processing has been performed for all the regions of the image data, the process terminates.

The functions are executed by storing the memory addresses of the functions to be called into the elements of arranged variables, and sequentially calling the functions corresponding to the addresses stored in the elements of the arranged variables. This is, however, time-consuming if a new function needs to be inserted between adjacent functions.

For example, in order to insert image processing function E as the second element of the arranged variables shown in FIG. 7, the addresses previously stored as the second and higher elements of the arranged variables are moved by one, and then the address of the new image processing function E is inserted in the unoccupied second element, which thus consumes time.

When one of the intermediate functions is deleted, the addresses positioned after the element corresponding to the deleted function are sequentially moved to occupy the element of the arranged variables, in which the corresponding address had been stored. This also consumes time.

When the arranged variables are dynamically reserved, the overhead in adding new data increases.

In addition, when the memory address of a function to be called is stored in each element of the arranged variables, the number of functions to be called is limited by the limited number of elements of the arranged variables. Accordingly, only a limited number of functions can be executed. For example, in the case of the arranged variables shown in FIG. 7, more than six functions cannot be executed.

### SUMMARY OF THE INVENTION

In view of the foregoing, the present invention has been realized, according to which optimum types of processing can be rapidly performed on data.

Embodiments of the present invention relate to a data processing apparatus that performs, in a predetermined order, one or more processes from among a plurality of processes, on predetermined data. The data processing apparatus includes a storage means (such as a memory) for storing a plurality of functions, each function describing a predetermined process and identifying a next function to be executed after execution of the predetermined process of the function, execution means (e.g., a controller) for executing the predetermined process described by each function, and change means (e.g., the controller) for changing the identification of the next function to be called by any of the functions stored in the storage means. Accordingly, the order in which the predetermined processes described by the functions stored in the storage means are executed by the execution means can be changed by the change means.

The data processing apparatus also can include determination means for determining whether or not each of the functions identifies a next function after the predetermined process of the function has been executed.

The determination means can perform the determination in accordance with predetermined information indicating whether or not the next function is identified.

The execution means can repeatedly execute the predetermined process of each function for only a predetermined number of times in accordance with predetermined repetition information.

The change means can change the identification of the next function to be executed to another function stored in the storage means.

The predetermined data can include image data, in which case, the predetermined processes are image processes including a gamma compensation process, a resolution-conversion process and an outline-adjustment process.

The predetermined data can include sound data.

### BRIEF DESCRIPTION OF THE DRAWINGS

The invention will be described in conjunction with the following drawings in which like reference numerals designate like elements and wherein:

FIG. 1 is a block diagram of an image processing apparatus, which is one type of a data processing apparatus, according to an embodiment of the present invention;

FIG. 2 is a flowchart showing the operation of each function stored in an image-processing-function storage unit shown in FIG. 1;

FIG. 3 illustrates conditions in which each function calls a next function;

FIG. 4 is a flowchart showing another operation of each function;

FIG. 5 illustrates conditions in which a function calls the next function after executing identical processing only three times;

FIG. 6 is a flowchart showing a conventional process that executes a plurality of functions in a predetermined order in accordance with processing order data;

FIG. 7 illustrates the structure of processing order data; and

FIG. 8 illustrates a condition in which new data is inserted into processing order data.

### DETAILED DESCRIPTION OF PREFERRED EMBODIMENTS

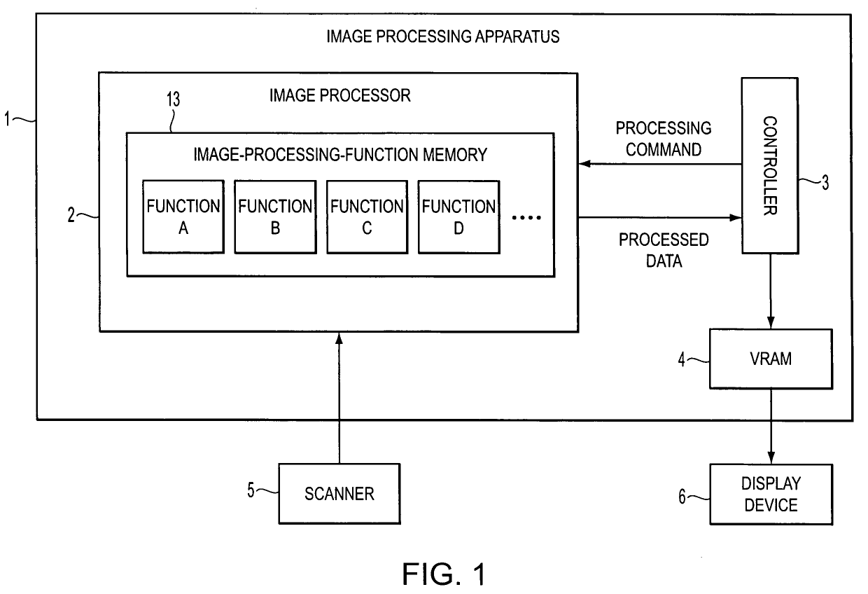

FIG. 1 is a block diagram of an image processing apparatus, which functions as one type of data processing apparatus, according to an embodiment of the present invention. An image processor 2 included in an image processing apparatus 1 includes an image-processing-function storage unit 13. The image processor 2 reads image data from a scanner 5, and performs image processing for the read image data by sequentially executing a plurality of image processing functions stored in the image-processing-function storage unit 13 in accordance with commands from a controller 3.

The controller 3 includes a central processing unit (CPU), a read-only memory (ROM) and a random access memory, and controls each component in accordance with a control program stored in the RAM. For example, the controller 3 provides the image processor 2 with a plurality of types of processing commands, and obtains the results of processes performed by the image processor 2. A video random access memory (VRAM) 4 stores the processing results provided from the image processor 2, and provides them to a display device 6. The display device 6 displays an image corresponding to the processing results provided from the VRAM 6.

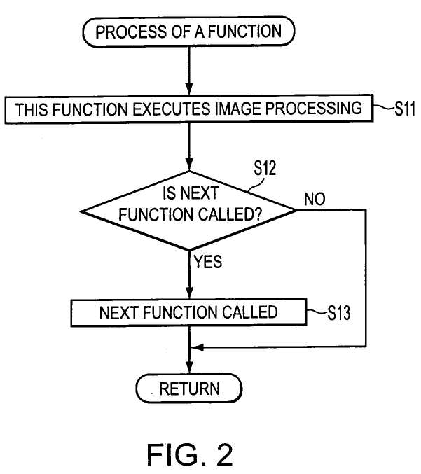

By referring to the flowchart in FIG. 2, an operation of each function will be described below.

Initially in step S11, a function executes a particular type of image processing operation. In step S12, a determination is made as to whether or not the function calls a next function. For example, this determination is made in accordance with a state of a flag that indicates whether or not to execute the next function. For example, if the flag value is one, the next function is executed. If the flag value is zero, the function process returns to its start. The value of the flag is set by the image processor 2.

In step S12, if it is determined that the function calls the next function, flow proceeds to step S13 to call the next function. When the process of step S13 has terminated, or when it is determined that the function has not called the next function in step S12, the function process terminates and returns to its start.

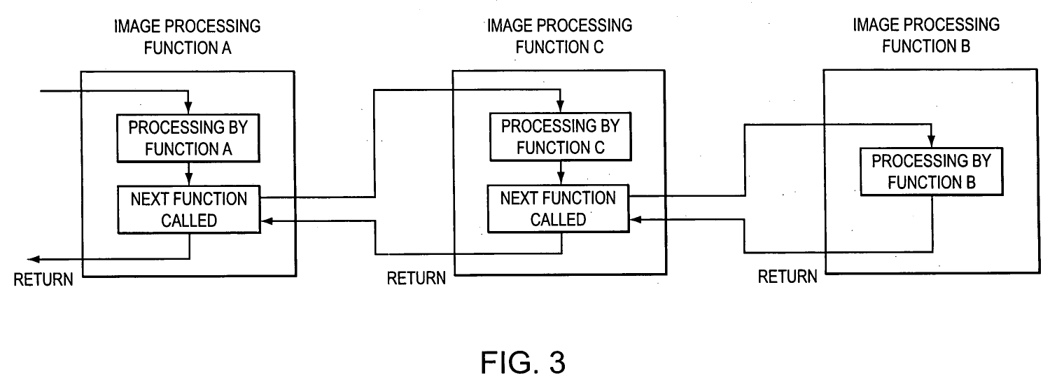

FIG. 3, which refers to FIG. 2, shows an example where functions A, B and C are called, and the process of each function is executed. Initially, image processing function A is called by the image processor 2, and the process of image processing function A is executed. Termination of the process calls the next function. In this case, image processing function C is called.

When image processing function C has been called, the process of image processing function C is executed. Termination of the process calls the next function. In this case, image processing function B is called. When image processing function B has been called, the process of image processing function B is executed. The function then returns to the former process. Image processing function C then returns to its former process since calling the next function has terminated. Image processing function A returns to the former process since calling the next function has terminated. In such a manner, image processing functions A, C and B are called and are executed in that order.

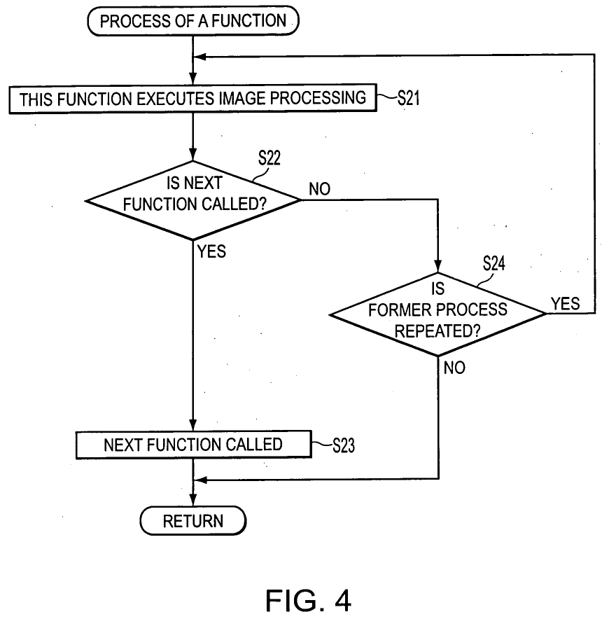

FIG. 4 shows a flowchart of another operation of each function. Initially in step S21, a function executes image processing. In step S22, a determination is made as to whether or not to call the next function. In other words, this determination is made in accordance with a flag showing whether or not to execute the next function. For example, if the flag value is one, the next function is executed. If the flag value is zero, the function process returns to its start. Again, the flag is set by the image processor 2.

In step S22, if it is determined to call the next function, flow proceeds to step S23, where the next function is called. If it is determined not to call the next function, flow proceeds to step S24, where it is determined whether or not to repeat the process of step S21 (former processing).

For example, the number of repetitions is set in a predetermined flag by the image processor 2. Whenever the process of step S21 is executed, the flag value is decremented by 1. In step S24, if the flag value is more than zero, it is determined to execute the former process again. If the flag value is zero or less, it is determined not to execute the former process again.

In step S24, if it is determined to execute the former process again, flow returns to step S21 and the processes positioned after step S21 are again executed. These processes are repeatedly executed for only the number of times set in the predetermined flag. When the process of step S24 has terminated, or when it is determined not to execute the former process again, processing of the function terminates and returns to its start.

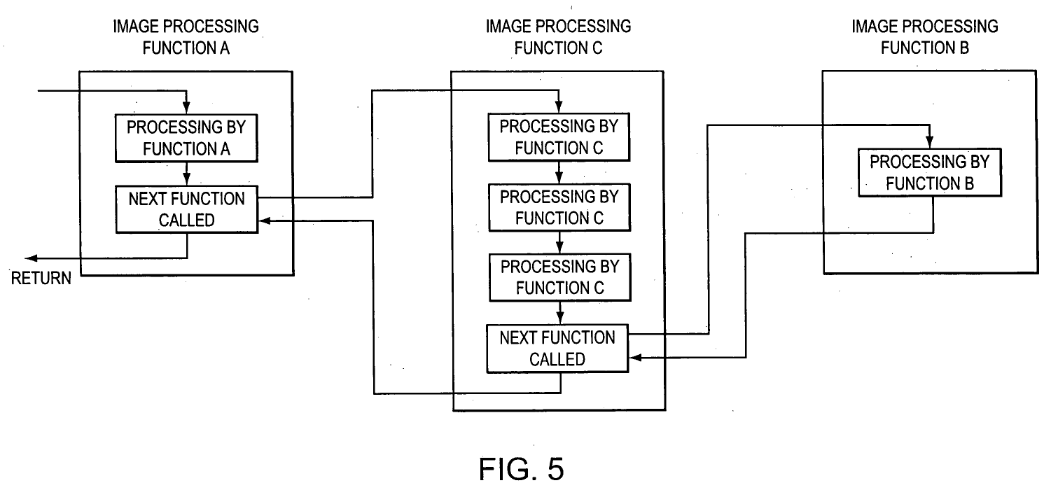

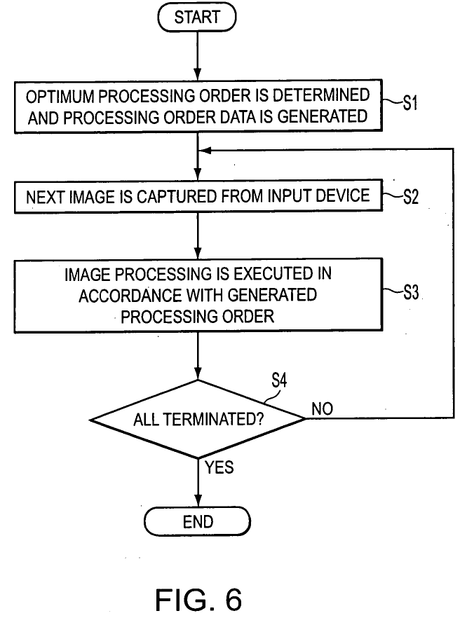

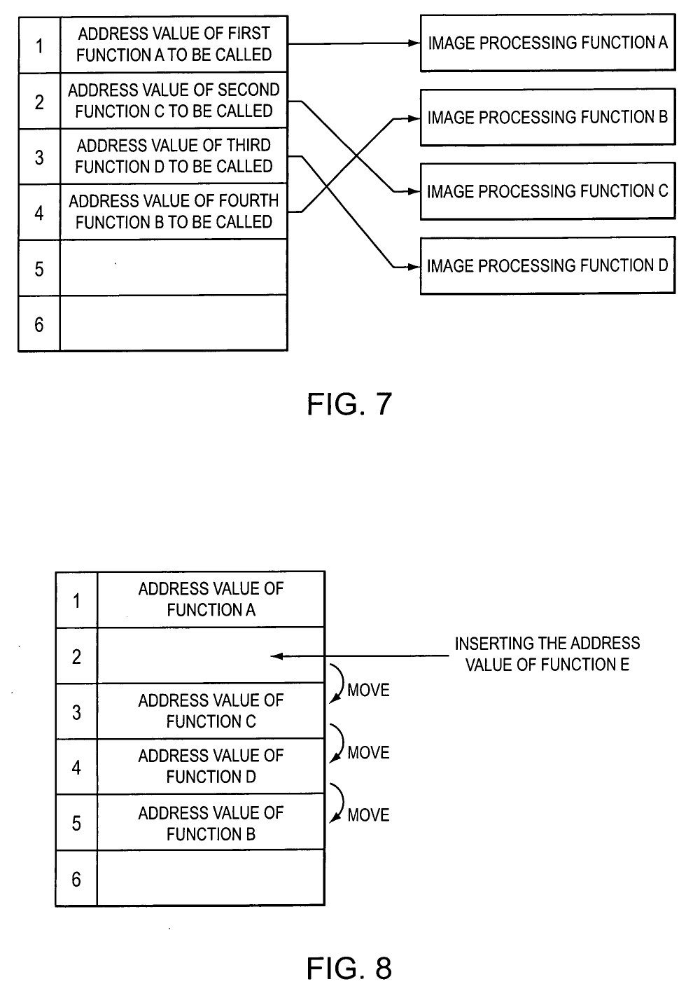

Accordingly, as shown in FIG. 5, for example, the predetermined process of image processing function C can be repeatedly executed three times. In other words, the image processor 2 sets the value of three (3) in the predetermined flag that designates the number of times that the process of image processing function C is to be performed. The image processing function C repeatedly executes the function process only three times in accordance with the flag as described with reference to FIG. 4.

This is effective for sequentially executing identical image processing operations for each image data only three times when, for example, the image data consists of red (R), green (G) and blue (B) image data.

As described above, by setting the address by which a next function can be called in a function, the optimal number of functions can be executed in a predetermined order. The number of executable functions can be increased to the storage capacity limit of a memory or the like storing the functions. A new function can be inserted after a predetermined function easily, by replacing the address of a function that is called by a function positioned just before the insertion position with the address of the new function to be inserted. The address of a function positioned just after the insertion position is set as the address of the function to be called by the new function.

In addition, each function itself calls the next function. Thus, it is only necessary to call the first function, which sufficiently eliminates the need for controlling the order of calling functions, thereby simplifying programs.

A plurality of types of processes for image data have been described in the foregoing embodiments. However, the present invention may be applied to a case in which a plurality of process types are performed on sound data and other data.

When the predetermined data includes image data, the predetermined processes can include image processes such as, for example, a gamma compensation process, a resolution-conversion process and an outline-adjustment process.

While this invention has been described in conjunction with specific embodiments thereof, it is evident that many alternatives, modifications and variations will be apparent to those skilled in the art. Accordingly, the preferred embodiments of the invention set forth herein are intended to be illustrative, not limiting. Various changes may be made without departing from the spirit and scope of the invention as defined in the following claims.

What is claimed is:

1. A data processing apparatus that performs, in a predetermined order, one or more processes from among a plurality of processes, on predetermined data, the data processing apparatus comprising:
storage means for storing a plurality of functions, each function including one of the plurality of processes and a call-out command that calls out a next one of the plurality of functions;
execution means for executing the process described by each of the plurality of functions; and
call out means for calling out the next one of the plurality of functions from the storage means in accordance with the call-out command of a function being executed by the execution means after the process of the function being executed by the execution means is completed.

2. The data processing apparatus of claim 1, wherein the execution means repeatedly executes the process of each of the plurality of functions for only a predetermined number of times in accordance with predetermined repetition information.

3. The data processing apparatus of claim 1, further comprising change means for changing the call-out command of the functions from a first one of the plurality of functions to a second one of the plurality of functions.

4. The data processing apparatus of claim 1, wherein the predetermined data includes image data.

5. The data processing apparatus of claim 4, wherein the processes are image processes including a gamma compensation process, a resolution-conversion process and an outline-adjustment process.

6. The data processing apparatus of claim 1, wherein the predetermined data includes sound data.

7. The data processing apparatus of claim 1, wherein the call-out command includes an address of the next function in the storage means.

8. A data processing apparatus that performs, in a predetermined order, one or more processes from among a plurality of processes, on predetermined data, the data processing apparatus comprising:
a memory that stores a plurality of functions, each function including one of the plurality of processes and a call-out command that calls out a next one of the plurality of functions; and
a controller that executes the process described by each of the plurality of functions and that calls out the next one of the plurality of functions from the memory in accordance with the call-out command of a function being executed by the controller after the process of the function being executed by the controller is completed.

9. The data processing apparatus of claim 8, wherein the controller repeatedly executes the process of each of the plurality of functions for only a predetermined number of times in accordance with predetermined repetition information.

10. The data processing apparatus of claim 8, wherein the controller can change the call-out command of the functions from a first one of the plurality of functions to a second one of the plurality of functions.

11. The data processing apparatus of claim 8, wherein the predetermined data includes image data.

12. The data processing apparatus of claim 11, wherein the processes are image processes including a gamma compensation process, a resolution-conversion process and an outline-adjustment process.

13. The data processing apparatus of claim 8, wherein the predetermined data includes sound data.

14. The data processing apparatus of claim 8, wherein the call-out command includes an address of the next function in the memory.

15. A method of processing data in which one or more processes from among a plurality of processes, are performed, in a predetermined order, on predetermined data, the method comprising the steps of:
storing in memory a plurality of functions, each function including one of the plurality of processes and a call-out command that calls out a next one of the plurality of functions; and
executing the one or more processes in the predetermined order by calling out the next one of the plurality of functions from the memory in accordance with the call-out command of a function being executed after the process of the function being executed is completed.

16. The method of claim 15, wherein the process of each of the plurality of functions is repeatedly executed for only a predetermined number of times in accordance with predetermined repetition information.

17. The method of claim 15, wherein the predetermined data includes image data.

18. The method of claim 17, wherein the predetermined processes are image processes including a gamma compensation process, a resolution-conversion process and an outline-adjustment process.

19. The method of claim 15, wherein the predetermined data includes sound data.

20. The method of claim 15, wherein the call-out command includes an address of the next function in the memory.
